(19) United States
(12) Patent Application Publication
(10) Pub. No.: US 2016/0291555 A1
(43) Pub. Date: Oct. 6, 2016

(54) CONTROLLING SYSTEM, CONTROLLING DEVICE, SETTING METHOD AND NON-TRANSITORY COMPUTER READABLE STORAGE MEDIUM

(71) Applicant: Aeon Matrix Inc., Taipei City (TW)

(72) Inventor: Ming-Je TSAI, Taipei City (TW)

(21) Appl. No.: 14/959,843

(22) Filed: Dec. 4, 2015

(30) Foreign Application Priority Data
Mar. 31, 2015 (TW) 104110521

(51) Int. Cl. G05B 15/02

(52) U.S. Cl. CPC G05B 15/02

(57) ABSTRACT

A controlling system includes a server, a first controlling device and at least one second controlling device. The first controlling device is connected with the server. The first controlling device receives an information coming from the server and sets a first value of the first controlling device according to the information. The second controlling device is connected with the server. The information represents a second value of the second controlling device. The second controlling device is disposed within a predefined geographical area.

### CROSS REFERENCE TO RELATED APPLICATIONS

This Non-provisional application claims priority under 35 U.S.C. §119(a) on Patent Application No(s). 104110521 filed in Taiwan, Republic of China on Mar. 31, 2015, the entire contents of which are hereby incorporated by reference.

### BACKGROUND OF THE INVENTION

1. Field of Invention

This invention relates to a controlling system, a controlling device, a setting method and a non-transitory computer readable storage medium.

2. Related Art

In the modern technology, the intrinsic parameters of many electronic apparatuses or systems are set by the manual operation. As to an irrigation system for example, the setting thereof is still mostly implemented by the manual operation, wherein, for example, the setting refers to what time the irrigation operation is implemented or how long each time of the irrigation operation of the irrigator lasts. However, the above-mentioned manner not only requires additional manpower but also lacks other references, and therefore is inconvenient and hard for achieving the accurate setting. Besides, there may be the problem of the insufficient or excessive irrigation, and even the waste of the water resource will be caused.

In view of the foregoing, the inventor thinks over a novel control system, control device, setting method and non-transitory computer readable storage medium, whereby the system parameter setting can be implemented without the manual operation, so that the implementation is more convenient and the parameter setting can be executed according to other information having reference value.

### SUMMARY OF THE INVENTION

To achieve the above objective, a controlling system of this invention includes a server, a first controlling device and at least one second controlling device. The first controlling device is connected with the server. The first controlling device receives an information coming from the server and sets a first value of the first controlling device according to the information. The second controlling device is connected with the server. The information represents a second value of the second controlling device. The second controlling device is disposed within a predefined geographical area.

In one embodiment, the geographical area is the area defined by the first controlling device as the center.

In one embodiment, the geographical area is the area of a city.

In one embodiment, the geographical area is an administrative division with the same postal code.

In one embodiment, the controlling system is suitable to control an irrigator. The first value represents irrigation start time, irrigation end time, irrigation duration, irrigation frequency or irrigation period.

To achieve the above objective, a controlling device of this invention is suitable to be connected with a server and comprises a transmission unit and a processing unit. The transmission unit is connected with the server and receives an information coming from the server. The information represents a second value of at least another controlling device. The processing unit is coupled with the transmission unit and sets a first value of the controlling device according to the information. The another controlling device is disposed within a predefined geographical area.

In one embodiment, the controlling device further comprises a storage unit coupled with the processing unit, and the information can be stored in the storage unit.

In one embodiment, the geographical area is the area defined by the controlling device as the center.

In one embodiment, the geographical area is the area of a city.

In one embodiment, the geographical area is an administrative division with the same postal code.

In one embodiment, the controlling device is suitable to control an irrigator. The first value represents irrigation start time, irrigation end time, irrigation duration, irrigation frequency or irrigation period.

To achieve the above objective, a setting method of this invention is suitable to set a first value of a first controlling device, and at least comprises steps of: receiving an information representing a second value of at least a second controlling device, wherein the second controlling device is disposed within a predefined geographical area; and setting a first value of the first controlling device according to the information.

In one embodiment, the geographical area is the area defined by the first controlling device as the center.

In one embodiment, the geographical area is the area of a city.

In one embodiment, the geographical area is an administrative division with the same postal code.

In one embodiment, the controlling device is used to control an irrigator, and the first value represents irrigation start time, irrigation end time, irrigation duration, irrigation frequency or irrigation period.

In one embodiment, the number of the second controlling device is plural, and the information is the average of the second values.

In one embodiment, the step of obtaining the average of the second values is to eliminate at least one extreme value from the second values and then compute the average of the remaining second values.

In one embodiment, the number of the second controlling device is plural, and the information is the mode of the second values.

In one embodiment, the number of the second controlling device is plural, and the information is the result of a weight calculation implemented to the second values according to the distances between each of the second controlling devices and the first controlling device.

To achieve the above objective, a non-transitory computer readable storage medium of this invention is applied to a first controlling device and comprises at least a program. The program at least executes steps of: receiving an information representing a second value of at least a second controlling device, wherein the second controlling device is disposed within a predefined geographical area; and setting a first value of the first controlling device according to the information.

In one embodiment, the geographical area is the area defined by the first controlling device as the center.

In one embodiment, the geographical area is the area of a city.

In one embodiment, the geographical area is an administrative division with the same postal code.

In one embodiment, the first controlling device is used to control an irrigator, and the first value represents irrigation start time, irrigation end time, irrigation duration, irrigation frequency or irrigation period.

In one embodiment, the number of the second controlling device is plural, and the information is the average of the second values.

In one embodiment, the step of obtaining the average is to eliminate at least one extreme value from the second values and then compute the average of the remaining second values.

In one embodiment, the number of the second controlling device is plural, and the information is the mode of the second values.

In one embodiment, the number of the second controlling device is plural, and the information is the result of a weight calculation implemented to the second values according to the distances between each of the second controlling devices and the first controlling device.

As mentioned above, in the controlling system, controlling device, setting method and non-transitory computer readable storage medium of this invention, the parameter of the first controlling device can be directly set according to the parameter of the second controlling device. Thereby, the inconvenience caused in the conventional art where the parameter setting needs to be implemented by manual operation can be avoided. Besides, because the second controlling device is located within a predefined geographical area, the parameter of the second controlling device has great reference value for the first controlling device.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic flowchart of a setting method of an embodiment of the invention;

FIG. 2 is a schematic diagram of a controlling system of an embodiment of the invention;

FIG. 3 is a function block diagram of the controlling system shown in FIG. 2; and

FIG. 4 is a schematic diagram of another controlling system of an embodiment of the invention.

### DETAILED DESCRIPTION OF THE INVENTION

The present invention will be apparent from the following detailed description, which proceeds with reference to the accompanying drawings, wherein the same references relate to the same elements.

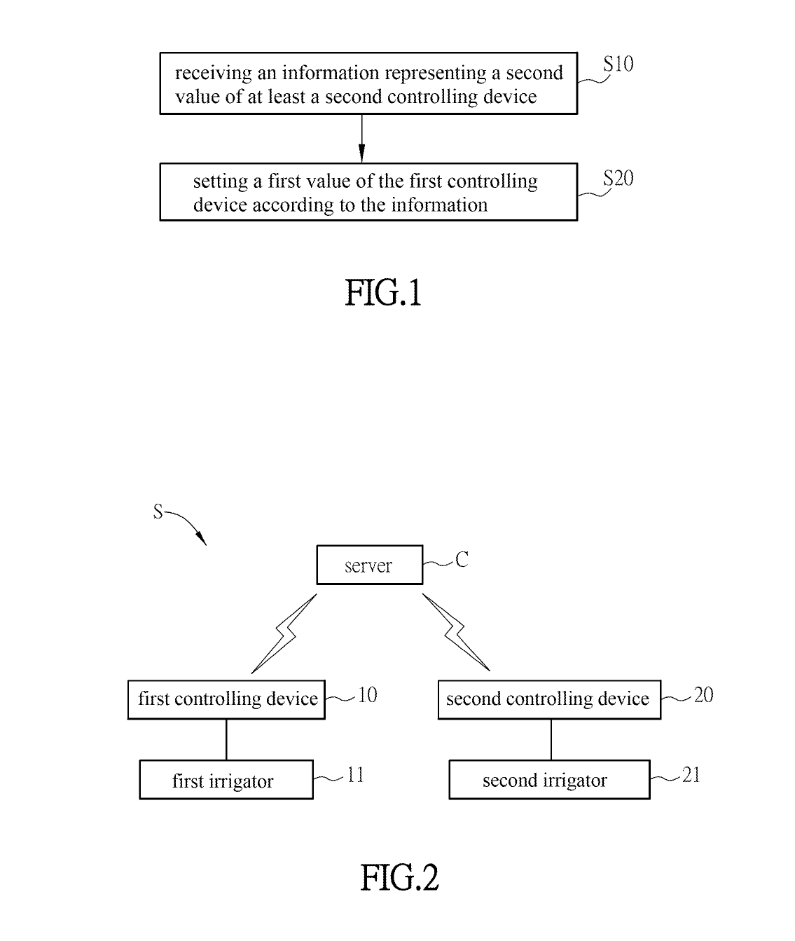

FIG. 1 is a schematic flowchart of a setting method of an embodiment of the invention, comprising the steps S10 and S20.

The step S10 is receiving an information representing a second value of at least a second controlling device.

The step S20 is setting a first value of the first controlling device according to the information.

FIG. 2 is a schematic diagram of a controlling system S of an embodiment of the invention, and the setting method shown in FIG. 1 can be applied to the controlling system S of FIG. 2. In detail, the setting method shown in FIG. 1 is used to set the first value of the first controlling device 10 shown in FIG. 2.

As shown in FIGS. 1 and 2, the controlling system S includes a server C, a first controlling device 10 and at least a second controlling device 20. The controlling system S can be an irrigation controlling system, an air-conditioning controlling system, a factory automation controlling system or other various controlling systems.

In this embodiment, the controlling system S is illustrated as an irrigation controlling system, so the first controlling device 10 and the second controlling device 20 can be irrigation controllers. The first controlling device 10 is used to control a first irrigator 11 to execute the irrigation operation and the second controlling device 20 is used to control a second irrigator 21 to execute the irrigation operation. In some embodiments, the first controlling device 10 and the first irrigator 11 can be integrated into a single device or they can be separate devices. However, if the first controlling device 10 and the first irrigator 11 are separate devices, it's better when they are closer to each other in location. Likewise, the second controlling device 20 and the second irrigator 21 can be integrated into a single device or they can be separate devices. However, if the second controlling device 20 and the second irrigator 21 are separate devices, it's better when they are closer to each other in location.

In this embodiment, the first controlling device 10 is connected with the server C and the second controlling device 20 is also connected with the server C. The second value of the second controlling device 20 is the related parameter that the second controlling device 20 uses to control the second irrigator 21. The server C can receive the second value of the second controlling device 20 and further generate an information related to the second value. Then, the first controlling device 10 will receive the information coming from the server C and set the first value of the first controlling device 10 according to the information.

In detail, the first value is the related parameter that the first controlling device 10 uses to control the first irrigator 11, and the second value is the related parameter that the second controlling device 20 uses to control the second irrigator 21. The type of the first value and second value is favorably a match with each other. For example, the second value can be the time point at which the second controlling device 20 controls the second irrigator 21 to start the irrigation. For example, the second value is 08:00, which represents the second controlling device 20 will control the second irrigator 21 to start the irrigation at 08:00. Then, the server C can generate the information which is related to the second value (08:00). The first controlling device 10 can further set the first value according to the information, for example, as 08:00 like the first value, which represents the first controlling device 10 will also control the first irrigator 11 to start the irrigation at 08:00.

In this embodiment, the second controlling device 20 is located within a predefined geographical area. In some embodiments, the so-called geographical area can be the area of a city or an administrative division with the same postal code. In other some embodiments, the geographical area also can be the area defined by the first controlling device 10 as the center, and the shape of the area can be a circle or another geometrical shape. For example, the geographical area can be a circle with the radius of 1 km and the center of the first controlling device 10.

In the controlling system S of this embodiment, the first value of the first controlling device 10 can be directly set according to the information related to the second value. Thereby, the inconvenience caused in the conventional art where the parameter setting needs to be implemented by manual operation can be avoided. Besides, because the second controlling device 20 is located within a predefined geographical area, the information has great reference value for the first controlling device 10.

In some embodiments, the first value and the second value may represent the time points at which the first irrigator 11 and the second irrigator 21 end the irrigation, respectively. Otherwise, the first value and the second value also may represent the durations which the irrigation operations of the first irrigator 11 and the second irrigator 21 last, respectively. Otherwise, the first value and the second value also may represent the irrigation frequencies of the first irrigator 11 and the second irrigator 21, respectively. Otherwise, the first value and the second value also may represent the irrigation periods of the first irrigator 11 and the second irrigator 21, respectively. However, the types of the first value and the second value are not limited thereto.

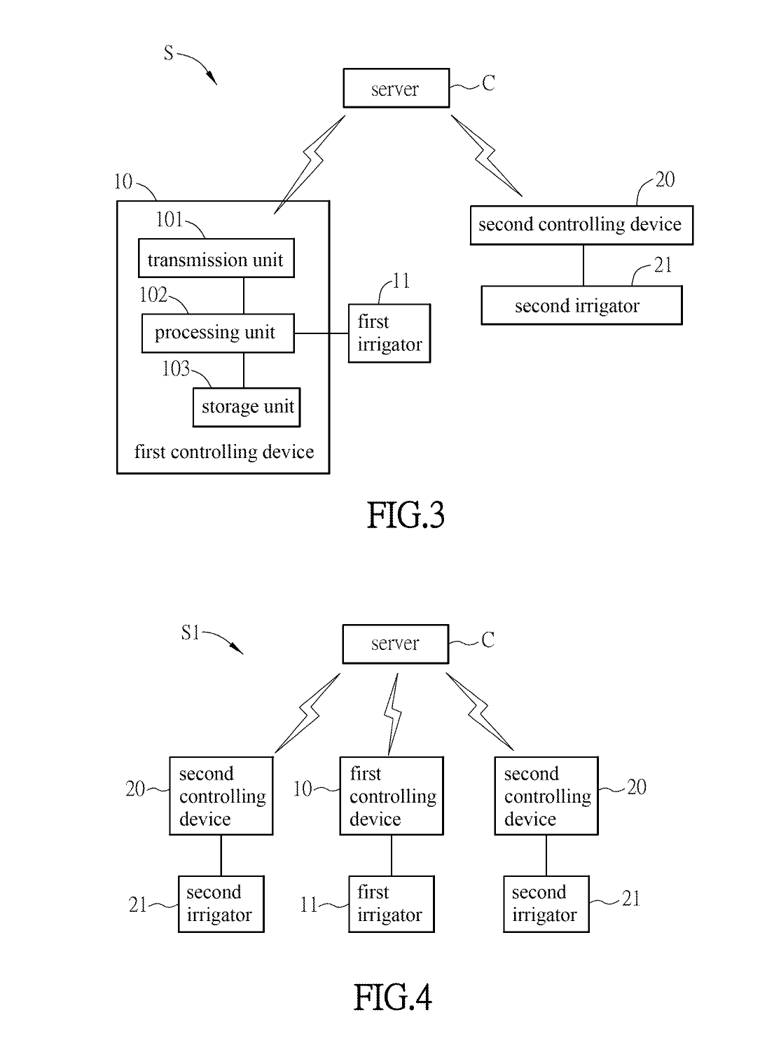

FIG. 3 is a function block diagram of the controlling system S shown in FIG. 2, further showing the function blocks included by the first controlling device 10. In this embodiment, the first controlling device 10 at least includes a transmission unit 101 and a processing unit 102. The transmission unit 101 is coupled with the processing unit 102. The transmission unit 101 can be connected with the server C and receive the information coming from the server C. Herein, the mentioned information is generated by the server C according to the second value of the second controlling device 20. The processing unit 102 can further set the first value of the first controlling device 10 according to the information and control the irrigation situation of the first irrigator 11 according to the first value.

In some embodiments, the first controlling device 10 can further include a storage unit 103, which is coupled with the processing unit 102. The information received by the transmission unit 101 can be stored in the storage unit 103 through the processing unit 102.

FIG. 4 is a schematic diagram of another controlling system Si of an embodiment of the invention. As shown in FIG. 4, the main difference from the above embodiment is that the controlling system S1 of this embodiment includes a plurality of second controlling devices 20 all connected with the server C. The server C can generate an information according to the second values of the second controlling devices 20, and the first controlling device 10 can set the first value according to the information. Although this embodiment is illustrated as the controlling system S1 includes two second controlling devices 20 for example, the number of the second controlling device 20 is not limited thereto. The controlling system of other embodiments may include three or more second controlling devices 20.

In this embodiment, because the information is generated according to the multiple second values of the multiple second controlling devices 20, the information in the controlling system S1 has more reference value for the first controlling device 10, in comparison with the previous embodiment.

In practice, when receiving the multiple second values coming from the multiple second controlling devices 20, the server C can implement the computation or processing to the second values. For example, the server C can compute the average of the second values. In some embodiments, before the server C computes the average of the second values, the extreme values, such as the maximum and minimum, among the second values will be eliminated and then the average of the remaining second values will be computed.

In other embodiments, the server C can receive a plurality of second values coming from a plurality of second controlling devices 20 and regard the mode of the second values as the information. Because this information is generated according to the second controlling devices 20 in the majority, the information has more reference value for the first controlling device 10.

In other some embodiments, the server C can implement the weight calculation to the second values which correspond to the distances between each of the second controlling devices 20 and the first controlling device 10. Because the weather condition or the soil condition at the location of the second controlling device 20 closer to the first controlling device 10 is similar to that of the first controlling device 10, the weight calculation implemented according to the second values corresponding to the distances can generate the information having more reference value.

Moreover, a non-transitory computer readable storage medium is also disclosed in this invention. Since the related content thereof can be comprehended by referring to the above embodiments, the related illustration is omitted here for conciseness. Furthermore, the second controlling device may further include a sensor, and the second value is a sensed value from the sensor. In one embodiment, the sensor may be a rain sensor. In another embodiment, the sensor may be a temperature sensor. By this arrangement, it is possible that the first controlling device may not include such sensor. In this case, because the first controlling device is within the same geographical area with the second controlling device, it can take benefit of the sensor of the second controlling device.

Summarily, in the controlling system, controlling device, setting method and non-transitory computer readable storage medium of this invention, the parameter of the first controlling device can be directly set according to the parameter of the second controlling device. Thereby, the inconvenience caused in the conventional art where the parameter setting needs to be implemented by manual operation can be avoided. Besides, because the second controlling device is located within a predefined geographical area, the parameter of the second controlling device has great reference value for the first controlling device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A controlling device suitable to be connected with a server, and comprising:
a transmission unit connected with the server and receiving an information coming from the server, the information representing a second value of at least another controlling device; and
a processing unit coupled with the transmission unit and setting a first value of the controlling device according to the information,
wherein the another controlling device is disposed within a predefined geographical area.

2. The controlling device as recited in claim 1, wherein the controlling device is also disposed in the predetermined geographical area.

3. The controlling device as recited in claim 1, wherein the geographical area is the area defined by the controlling device as the center.

4. The controlling device as recited in claim 1, wherein the geographical area is the area of a city.

5. The controlling device as recited in claim 1, wherein the geographical area is an administrative division with the same postal code.

6. The controlling device as recited in claim 1, which is suitable to control an irrigator, wherein the first value represents irrigation start time, irrigation end time, irrigation duration, irrigation frequency or irrigation period.

7. The controlling device as recited in claim 1, wherein said another controlling device further comprises a sensor, and the second value is a sensed value from the sensor.

8. The controlling device as recited in claim 6, wherein the sensor is a rain sensor or a temperature sensor.

9. A setting method suitable to set a first value of a first controlling device, and at least comprising steps of:
receiving an information representing a second value of at least a second controlling device, wherein the second controlling device is disposed within a predefined geographical area; and
setting a first value of the first controlling device according to the information.

10. The setting method as recited in claim 9, wherein the first controlling device is also disposed in the predetermined geographical area.

11. The setting method as recited in claim 9, wherein the geographical area is the area defined by the first controlling device as the center.

12. The setting method as recited in claim 9, wherein the geographical area is the area of a city.

13. The setting method as recited in claim 9, wherein the geographical area is an administrative division with the same postal code.

14. The setting method as recited in claim 9, wherein the first controlling device is used to control an irrigator, and the first value represents irrigation start time, irrigation end time, irrigation duration, irrigation frequency or irrigation period.

15. The setting method as recited in claim 9, wherein the number of the second controlling device is plural, and the information is the average of the second values.

16. The setting method as recited in claim 15, wherein the step of obtaining the average is to eliminate at least one extreme value from the second values and then compute the average of the remaining second values.

17. The setting method as recited in claim 9, wherein the number of the second controlling device is plural, and the information is the mode of the second values.

18. The setting method as recited in claim 9, wherein the number of the second controlling device is plural, and the information is the result of a weight calculation implemented to the second values according to the distances between each of the second controlling devices and the first controlling device.

19. The setting method as recited in claim 9, wherein the second controlling device further comprises a sensor, and the second value is a sensed value from the sensor.

20. The setting method as recited in claim 18, wherein the sensor is a rain sensor or a temperature sensor.

21. A non-transitory computer readable storage medium applied to a first controlling device and comprising at least a program, the program at least executing steps of:
receiving an information representing a second value of at least a second controlling device, wherein the second controlling device is disposed within a predefined geographical area; and
setting a first value of the first controlling device according to the information.

22. The non-transitory computer readable storage medium as recited in claim 21, wherein the first controlling device is also disposed in the predetermined geographical area.

23. The non-transitory computer readable storage medium as recited in claim 21, wherein the geographical area is the area defined by the first controlling device as the center.

24. The non-transitory computer readable storage medium as recited in claim 21, wherein the geographical area is the area of a city.

25. The non-transitory computer readable storage medium as recited in claim 21, wherein the geographical area is an administrative division with the same postal code.

26. The non-transitory computer readable storage medium as recited in claim 21, wherein the first controlling device is used to control an irrigator, and the first value represents irrigation start time, irrigation end time, irrigation duration, irrigation frequency or irrigation period.

27. The non-transitory computer readable storage medium as recited in claim 21, wherein the number of the second controlling device is plural, and the information is the average of the second values.

28. The non-transitory computer readable storage medium as recited in claim 26, wherein the step of obtaining the average is to eliminate at least one extreme value from the second values and then compute the average of the remaining second values.

29. The non-transitory computer readable storage medium as recited in claim 21, wherein the number of the second controlling device is plural, and the information is the mode of the second values.

30. The non-transitory computer readable storage medium as recited in claim 21, wherein the number of the second controlling device is plural, and the information is the result of a weight calculation implemented to the second values according to the distances between each of the second controlling devices and the first controlling device.

31. The non-transitory computer readable storage medium as recited in claim 21, wherein the second controlling device further comprises a sensor, and the second value is a sensed value from the sensor.

32. The non-transitory computer readable storage medium as recited in claim 30, wherein the sensor is a rain sensor or a temperature sensor.
